(19) United States
(12) Patent Application Publication
(10) Pub. No.: US 2004/0088161 A1
(43) Pub. Date: May 6, 2004

(54) Method and apparatus to prevent speech dropout in a low-latency text-to-speech system

(76) Inventors: Gerald Corrigan, Chicago, IL (US); Steven Albrecht, Glenview, IL (US)

Correspondence Address: MOTOROLA, INC., 1303 EAST ALGONQUIN ROAD, IL01/3RD, SCHAUMBURG, IL, 60196

(21) Appl. No.: 10/283,640

(22) Filed: Oct. 30, 2002

(51) Int. Cl. G10L 19/14

(52) U.S. Cl. 704/211

(57) ABSTRACT

To address the need for a method and apparatus for preventing speech dropout in a low-latency text-to-speech system, a method and apparatus for preventing such speech dropout is described herein. In accordance with the preferred embodiment of the present invention the rate of speech is allowed to vary based on an amount of data existing within the buffer. More particularly, as the buffer empties, the rate of speech slows, reducing the chances that the output buffer will empty.

### FIELD OF THE INVENTION

The present invention relates generally to text-to-speech conversion and in particular, to a method and apparatus for preventing speech dropout in a low-latency text-to-speech system.

### BACKGROUND OF THE INVENTION

Text-to-speech (TTS) conversion is well known in the art. Such conversion typically includes buffering applications both prior to, and after voice decoding. A typical prior-art text-to-speech system 100 is shown in FIG. 1. In this system, text 102 is provided to an acoustic parameter generator 104, which generates acoustic data 106 and stores it in acoustic data buffer 108. As known in the art, acoustic data 106 in acoustic data buffer 108 may be a series of vectors of vocoder parameters, or it may be parameters used to compute an appropriate vector of vocoder parameters at some given time.

Vocoder parameters 110 derived from acoustic data 106 are presented to a vocoder 112, which generates speech data 114. A voice coder, or vocoder, frequently consists of a voice encoder, which converts speech to an encoded form, and a voice decoder, which converts the encoded form to speech. Text-to-speech conversion typically uses only the voice decoder, the encoded form being stored or generated by some means that does not use speech as an input. In the following discussion, the term “vocoder” refers to a voice decoder, and “vocoder parameters” refers to the encoded form.

Typically, speech data 114 is stored in output buffer 116 until it is provided as output speech 118. Data is removed from buffer 108 at a fixed rate. If output buffer 116 becomes empty, there will be an undesirable silence inserted into the generated speech. Assuming vocoder 112 can run fast enough to keep output buffer 116 filled, the gap in generated speech will only occur if acoustic data buffer 108 becomes empty.

Prior-art methods for keeping data buffer 108 filled have included increasing the size of output buffer 116. In particular, the probability of buffer 116 emptying can be reduced by having a large amount of data in buffer 116 when audio output begins. Because computing the data to fill output buffer 116 takes time, increasing the buffer size comes at the cost of increased latency, or delay between presenting the text to the TTS engine and the start of speech, which is undesirable in a dialog system. Therefore, a need exists for a method and apparatus for preventing speech dropout in a low-latency text-to-speech system.

### BRIEF DESCRIPTION OF THE DRAWINGS

FIG. 1 is a block diagram of a prior-art text-to-speech system.

FIG. 2 is a block diagram of a text-to-speech system in accordance with the preferred embodiment of the present invention.

FIG. 3 is a flow chart showing operation of the text-to-speech system in accordance with the preferred embodiment of the present invention.

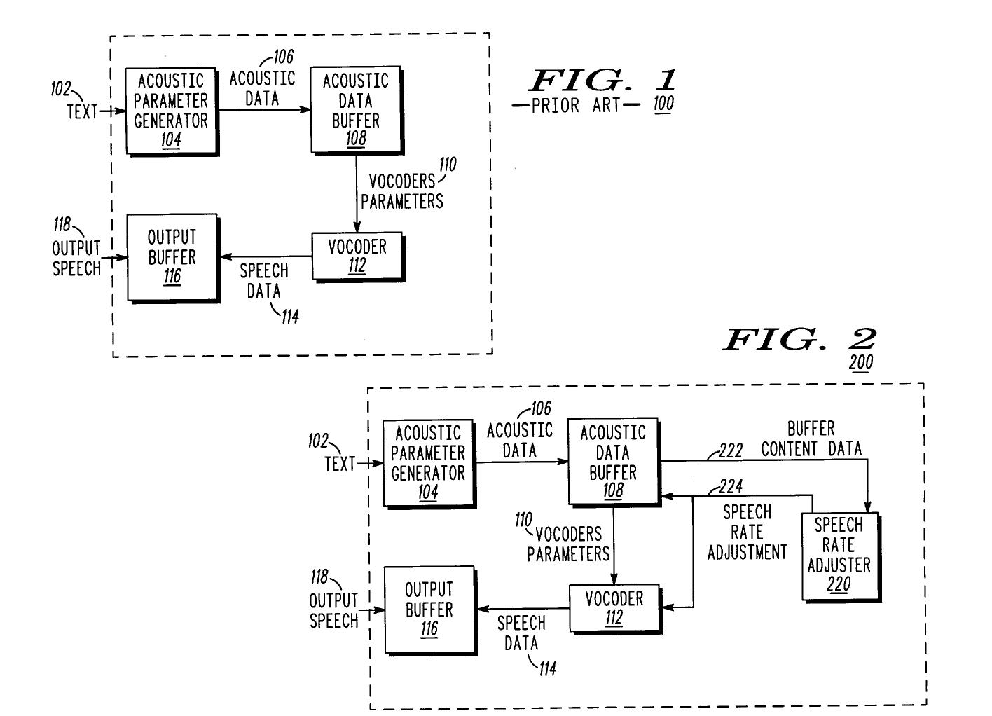

### DETAILED DESCRIPTION OF THE DRAWINGS

To address the need for a method and apparatus for preventing speech dropout in a low-latency text-to-speech system, a method and apparatus for preventing such speech dropout is described herein. In accordance with the preferred embodiment of the present invention the rate of speech is allowed to vary based on an amount of data existing within the buffer. More particularly, as the buffer empties, the rate of speech slows, reducing the chances that the output buffer will empty. The reduction in probability that the output buffer will empty is achieved without increasing the size of the buffer and adding system latency.

The present invention encompasses a method comprising the steps of estimating an amount of data existing within a buffer, and adjusting a rate of speech for a vocoder in response to the amount of data existing within the buffer.

The present invention additionally encompasses a method for preventing speech dropout in a low-latency text-to-speech system. The method comprises the steps of receiving acoustic data and storing the acoustic data within a buffer. A an amount of acoustic data existing within the buffer is then determined and a rate of speech of a vocoder is modified in response to the amount of acoustic data existing within the buffer.

The present invention additionally encompasses an apparatus comprising a buffer, a vocoder coupled to the buffer, and a speech rate adjuster coupled to the buffer. In the preferred embodiment of the present invention the speech rate adjuster adapted to adjust a rate of speech dependent upon an amount of data existing within the buffer.

Turning now to the drawings, wherein like numerals designate like components, FIG. 2 is a block diagram of text-to-speech system 200 in accordance with the preferred embodiment of the present invention. As is evident, speech rate adjuster 220 has been added to apparatus 100. In the preferred embodiment of the present invention adjuster 220 comprises a Digital Signal Processor, an Application Specific Integrated Circuit, or a gate array configured in well known manners with processors, memories, instruction sets, and the like, which operate to perform the function set forth herein. In a similar manner, adjuster 220 may be stored in a memory unit of a computer, and comprise those steps necessary to perform the function set forth herein.

In accordance with the preferred embodiment of the present invention, speech rate adjuster 220 accepts buffer content data 222 from acoustic data buffer 108 including an estimate of the amount of data stored in acoustic data buffer 108. From this, a speech rate is computed, which will be reduced when there is a risk of buffer 108 becoming empty. A speech rate adjustment 224 is then provided to at least one of the acoustic data buffer 108 and the vocoder 112. As discussed above, acoustic data buffer 108 contains data from which vectors of vocoder parameters may be computed at successive moments in time to generate speech at a planned speech rate. As one of ordinary skill in the art will recognize, the rate of speech may be modified in several ways.

In a first embodiment of the present invention speech rate adjustment 224 consists of a reduction in the time step between the times at which successive vectors of vocoder parameters are computed. For example, consider a system with a vocoder that generates a ten millisecond frame of speech for every vector of vocoder parameters, and with an acoustic data buffer that stores data for each phoneme allowing a vector of vocoder parameters to be computed for any given time relative to the start of the phoneme. In the preferred embodiment of the present invention when adjuster 220 senses that buffer 108 is emptying, it will instruct vocoder 112 to compute vocoder parameters for every eight milliseconds in the phoneme as was originally scheduled, while still synthesizing ten milliseconds of speech for every vector of vocoder parameters. In this case, twenty-five vectors of vocoder parameters, resulting in two hundred fifty milliseconds of speech, would be generated for a phoneme that had originally been scheduled to have a duration of two hundred milliseconds. This would mean that the acoustic data buffer would be emptying at a rate twenty percent slower than normal. As the buffer continues to empty, the rate at which the buffer is emptying could be reduced still more by reducing the interval at which the parameters are computed still further.

In a further embodiment, the change in the time step between the times at which successive vectors of vocoder parameters are dependent on the identity of the phoneme in which the frame of speech occurs. For example, if buffer 108 contained data for the phonemes /b/ and /a/, the time step might be reduced more during the /a/ than the /b/, thereby lengthening the /a/ by a greater percentage, as would be the case when the speech rate is reduced in natural speech.

In a second embodiment of the present invention a number of frames stored in buffer 108 is increased. More particularly, the data stored in buffer 108 may consist of the vectors of vocoder parameters, each vector describing a fixed period of speech. In the second embodiment of the invention, when adjuster 220 determines that buffer 108 is emptying, it increases the number of vectors of parameters stored in buffer 108, thus increasing the number of vectors sent to vocoder 112. This increase may be produced by repetition or interpolation of the vectors. For example, when adjuster 220 determines that buffer 108 is emptying, it may cause every fourth vector to be repeated (inserted into buffer 108), resulting in fifty milliseconds of generated speech where normally only forty would be produced. Again, this represents a twenty percent reduction in the rate at which acoustic data buffer 108 is emptying. Again, if buffer 108 continues to empty, the rate at which it does so may be reduced further by repeating even more vectors of vocoder parameters. Also, more vectors may be added based on the identity of the phoneme. For example, vectors may be added during phonemes that are typically lengthened more in natural speech when an individual is speaking more slowly. Such a process would replicate or insert vectors for phonemes such as /a/, /s/, /w/, . . . etc.

In a third embodiment, of the present invention, the length of the speech frame generated for each vector of vocoder parameters is increased. When adjuster 220 determines that buffer 108 is emptying, adjuster 220 instructs vocoder 112 to lengthen the frame of speech generated by vocoder 112. For example, if the frame length is changed from ten to twelve milliseconds, it would require only ten, rather than twelve, vectors of vocoder parameters to generate 120 milliseconds of speech, resulting in a reduction of seventeen percent in the rate at which buffer 108 empties. Again, if buffer 108 continues to empty, the rate at which it does so may be reduced further by lengthening the frame further. Also, the increase of the frame length may depend on the phoneme being generated. For example, a frame occurring during a long vowel may be lengthened more than a frame occurring during a voiced stop consonant, lengthening the vowel more than the voiced stop. (In natural speech, someone speaking more slowly typically lengthens long vowels more than voiced stops.)

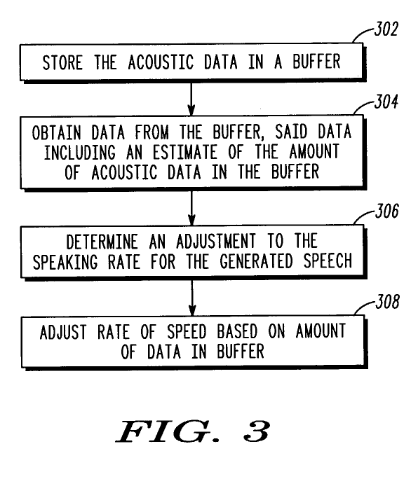

FIG. 3 is a flow chart showing the operation of the TTS system of FIG. 2 in accordance with the preferred embodiment of the present invention. The logic flow begins at step 302 where acoustic data 106 is stored in a buffer 108. As discussed above, acoustic data 106 comprises a series of vocoder parameter vectors utilized to generate a portion of the speech waveform. The logic flow continues to step 304, where data is obtained from buffer 108. As discussed above, the data includes an estimate of the amount of acoustic data existing within buffer 108. Next, at step 306 adjustment 224 is determined to the speaking rate for the generated speech. As discussed above, adjustment 224 is based on an amount of data existing within buffer 108. At step 308 a rate of speech is modified in response to the amount of data existing within buffer 108. As discussed above, the adjustment is applied to the process of extracting the parameter vectors from the buffer and using the vocoder to generate speech from those parameters. In a first embodiment speech rate adjustment 224 consists of a reduction in the time step between the times at which successive vectors of vocoder parameters are computed, in a second embodiment adjustment 224 comprises a series of duplicated parameter vectors, and in a third embodiment adjustment 224 consists of an increase in the duration of the speech frame generated by the vocoder 112.

Because the rate of speech is allowed to vary based on buffer size, in the preferred embodiment of the present invention buffer 108 has a much-reduced chance of emptying, greatly improving system performance. Additionally, the system performance is improved without increasing the size of buffer 108 (adding system latency).

While the invention has been particularly shown and described with reference to a particular embodiment, it will be understood by those skilled in the art that various changes in form and details may be made therein without departing from the spirit and scope of the invention. For example, although the above description was given with rate adjuster 220 either adding selective speech frames to buffer 108 or increasing the frame duration within vocoder 112, one of ordinary skill in the art will recognize that a combination of both may be simultaneously done when buffer 108 runs low. Thus, as one of ordinary skill in the art will recognize, speech rate adjuster 220 need not be coupled to vocoder 112 if speech rate adjustment 224 does not modify vocoder 112 (such as the time step between the times at which successive vectors of vocoder parameters are computed the duration of the speech frame). Additionally, although the above embodiments where described with respect to determining an amount of data within acoustic data buffer 108, one of ordinary skill in the art will recognize that an amount of data existing within output buffer 116 may just as easily be determined, and a rate of speech adjusted based on the amount of data within output buffer 116. It is intended that such changes come within the scope of the following claims.

1. A method comprising the steps of:
estimating an amount of data existing within a buffer; and
adjusting a rate of speech for a vocoder in response to the amount of data existing within the buffer.

2. The method of claim 1 wherein the step of adjusting the rate of speech for the vocoder comprises the step of:
reducing a time step between times at which successive vectors of vocoder parameters are computed.

3. The method of claim 2 wherein the step of reducing is based on an identity of a phoneme.

4. The method of claim 1 wherein the step of adjusting the rate of speech for the vocoder comprises the step of:
duplicating or inserting vocoder vectors within the buffer.

5. The method of claim 4 wherein the step of duplicating or inserting is based on an identity of a phoneme.

6. The method of claim 1 wherein the step of adjusting the rate of speech for the vocoder comprises the step of:
increasing a duration of a speech frame generated by the vocoder.

7. The method of claim 6 wherein the step of increasing the duration of the speech frame is dependent upon an identity of a phoneme.

8. The method of claim 1 wherein the step of adjusting the rate of speech for the vocoder is taken from the group consisting of reducing a time step between times at which successive vectors of vocoder parameters are computed, duplicating or inserting vocoder vectors within the buffer, and increasing a duration of a speech frame generated by the vocoder.

9. The method of claim 8 wherein the step of adjusting the rate of speech for the vocoder is dependent upon an identity of a phoneme.

10. The method of claim 1 wherein the step of adjusting the rate of speech for the vocoder is dependent upon an identity of a phoneme.

11. A method for preventing speech dropout in a low-latency text-to-speech system, the method comprising the steps of:
receiving acoustic data;
storing the acoustic data within a buffer;
determining an amount of acoustic data existing within the buffer; and
modifying a rate of speech of a vocoder in response to the amount of acoustic data existing within the buffer.

12. The method of claim 11 wherein the step of modifying the rate of speech is dependent upon an identity of a phoneme existing within the buffer.

13. The method of claim 11 wherein the step of modifying the rate of speech comprises the step of:
reducing a time step between times at which successive vectors of vocoder parameters are computed.

14. The method of claim 11 wherein the step of modifying the rate of speech comprises the step of:
duplicating or inserting vocoder vectors within the buffer.

15. The method of claim 11 wherein the step of modifying the rate of speech comprises the step of:
increasing a duration of a speech frame generated by the vocoder.

16. The method of claim 11 wherein the step of modifying the rate of speech is taken from the group consisting of reducing a time step between times at which successive vectors of vocoder parameters are computed, duplicating or inserting vocoder vectors within the buffer, and increasing a duration of a speech frame generated by the vocoder.

17. An apparatus comprising:
a buffer;
a vocoder coupled to the buffer; and
a speech rate adjuster coupled to the buffer, the speech rate adjuster adapted to adjust a rate of speech dependent upon an amount of data existing within the buffer.

18. The apparatus of claim 17 wherein the rate of speech is adjusted by reducing a time step between times at which successive vectors of vocoder parameters are computed.

19. The apparatus of claim 17 wherein the rate of speech is adjusted by duplicating or inserting vocoder vectors within the buffer.

20. The apparatus of claim 17 wherein the rate of speech is adjusted by increasing a duration of a speech frame generated by the vocoder.
